(19) United States
(12) Patent Application Publication
(10) Pub. No.: US 2015/0020095 A1
(43) Pub. Date: Jan. 15, 2015

(54) VIDEO STREAM COMBINATION FOR VIDEO ADVERTISEMENT

(71) Applicant: KT CORPORATION, Gyeonggi-do (KR)

(72) Inventors: Young-Il YOO, Gyeonggi-do (KR); Dong-Hoon KIM, Gyeonggi-do (KR); I-Gil KIM, Gyeonggi-do (KR); Gyu-Tae BAEK, Seoul (KR)

(73) Assignee: KT CORPORATION

(21) Appl. No.: 14/332,328

(22) Filed: Jul. 15, 2014

(30) Foreign Application Priority Data
Jul. 15, 2013 (KR) 10-2013-0083075

(51) Int. Cl. H04N 21/2668; H04N 21/2365; H04N 21/242; H04N 21/234; H04N 21/2343; H04N 21/236; H04N 21/81

(52) U.S. Cl. CPC H04N 21/2668; H04N 21/23614; H04N 21/2365; H04N 21/812; H04N 21/23424; H04N 21/2343; H04N 21/242
USPC 725/34

(57) ABSTRACT

The disclosure is related to combining a plurality of video streams, and to providing a variety of video advertisements using a video stream combination procedure. Particularly, the video stream combination procedure according to the present embodiment may include extracting a plurality of encoded video data included in a plurality of video streams, and creating a single combined video stream by considering each extracted encoded video data as slice group data. Furthermore, an advertisement stream may be included in the single combined video stream, by using such video stream combination procedure.

### CROSS REFERENCE TO PRIOR APPLICATIONS

The present application claims priority under 35 U.S.C. §119 to Korean Patent Application No. 10-2013-0083075 (filed on Jul. 15, 2013), which is hereby incorporated herein by reference in its entirety.

The subject matter of this application is related to U.S. patent application Ser. No. ______ (filed on ______, 2014), as Attorney Docket No. 801.0143 and U.S. patent application Ser. No. ______ (filed on ______, 2014), as Attorney Docket No. 801.0144, the teachings of which are incorporated herein their entirety by reference.

### TECHNICAL FIELD

The present disclosure relates to a video data processing and, in particular, to combining a plurality of video streams and to providing a variety of video advertisements such as a local video advertisement by using a video stream combination.

### BACKGROUND

A typical broadcast service provider transmits the same channel signals to all viewers using a variety of transmission schemes, such as a multicast transmission scheme or a broadcast transmission scheme. Since the same channel signals are transmitted, the same video screens are produced and displayed on display devices at the viewer side. That is, all viewers are watching the same video screens. However, there is a demand to have a customized broadcast service or a targeted video advertisement service according to viewer's characteristics (e.g., viewer preference, tendency, location, ages, etc.).

In order to add advertisements (especially, a local advertisement) to a broadcast stream, still images or texts associated with the advertisements are provided through a separate session from a broadcast channel stream. A user-side device (e.g., a set-top box, a smart TV, etc.) adds the images/texts to the broadcast channel stream and displays the images/texts with a corresponding video stream in an overlay manner. The user-side device performs decoding of the received broadcast channel stream and overlays the advertisement image/text provided through a separate session, on screen of the decoded broadcast channel stream. In such typical scheme, it may be difficult (or substantially impossible) to add (or combine) a ‘video’ advertisement other than a static advertisement on the decoded broadcast channel stream, through an overlay scheme.

Lately, TV devices using a picture-in-picture (PIP) technique has been introduced. The PIP technique enables the TV devices to display a plurality of broadcast channels on a single screen. In order to perform such PIP operation, a TV device receives a plurality of broadcast signals, decodes each of the received broadcast signals through a plurality of decoders corresponding to the number of the received broadcast signals, and displays the decoded broadcast signals on a single screen by using PIP technique. In other words, in order to display a plurality of broadcast channels on a single screen, the TV device may be required to include a plurality of decoders.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a single combined video stream may be created using a plurality of ‘encoded video data’ (i.e., video bitstream) extracted from a plurality of video streams, without decoding each of the plurality of video streams. Such a video stream combination procedure may include (i) extracting a plurality of encoded video data included in a plurality of video streams and (ii) creating a single combined video stream by considering handling each extracted encoded video data as slice group data. Furthermore, an advertisement stream (e.g., a local advertisement stream) may be included in the single combined video stream, by using such a video stream combination procedure.

In accordance with at least one embodiment, a method may be provided for performing a video stream combination. The method may include receiving a plurality of independent video streams; extracting encoded video data in a unit of video frame from each of the plurality of independent video streams; creating a plurality of slice group data to be used for creation of a single combined video stream, from a plurality of encoded video data; creating slice group header information per slice group data; and forming the single combined video stream including the plurality of slice group data and a plurality of slice group header information.

The creating a plurality of slice group data may include at least one of (i) adjusting a data size of each encoded video data and (ii) adding guard area data to each encoded video data.

The adjusting may include performing a data size adjustment such that each encoded video data is displayed at a predetermined screen area on a target display screen.

The data size adjustment may be performed according to a mapping relation of each video stream and a slice group corresponding to the target screen area.

The adding guard area data may include adding the guard area data to each size-adjusted encoded video data such that a decoding error due to neighboring slice groups is prevented.

At least one of the plurality of independent video streams may be an advertisement video stream.

The slice group header information may include position information associated with each slice group corresponding to each slice group data.

The position information may be determined such that each encoded video data is displayed at a predetermined screen area on a target display screen.

The method may further include creating a single combined transport stream (TS) by multiplexing at least one of the single combined video stream, corresponding audio streams, and additional information.

The additional information may include at least one of (i) metadata associated with the single combined video stream, and (ii) access information of content servers providing the plurality of independent video streams.

The method may further include performing a frame type synchronization for the plurality of slice group data.

In a case that at least one of the plurality of independent video streams is a different single combined video stream, the extracting may include extracting a plurality of encoded video data in a unit of video frame from the different single combined video stream.

The slice group data and the slice header information may be based on a flexible macroblock ordering (FMO) technique.

In accordance with other embodiments, a method may provide an advertisement using a video stream combination. The method may include receiving at least one video stream from at least one content providing server; receiving at least one advertisement stream from at least one advertisement server; extracting encoded video data in a unit of video frame, from each of the at least one video stream and the at least one advertisement stream; creating a plurality of slice group data to be used for creation of a single combined video stream, from a plurality of encoded video data; creating slice group header information per slice group data; and forming the single combined video stream including the plurality of slice group data and a plurality of slice group header information.

At least one of the at least one advertisement stream may be a local advertisement stream associated with user characteristics.

The creating a plurality of slice group data may include at least one of (i) adjusting a data size of each encoded video data such that each encoded video data is displayed at a predetermined screen area on a target display screen; and (ii) adding guard area data to each encoded video data.

In a case that at least one of the at least one video stream is a different single combined video stream, the extracting may include extracting a plurality of encoded video data in a unit of video frame from the different single combined video stream.

In accordance with another embodiment, a system may be provided for performing a video stream combination, the system may include a receiver, a video combination processor, and a receiver. Herein, the receiver may be configured to receive a plurality of independent video streams. The video combination processor may be configured to (i) extract encoded video data in a unit of video frame from each of the plurality of independent video streams, (ii) create a plurality of slice group data to be used for creation of a single combined video stream, from a plurality of encoded video data, (iii) create slice group header information per slice group data, and (iv) form the single combined video stream including the plurality of slice group data and a plurality of slice group header information. The transmitter may be configured to transmit the single combined video stream to at least one of another video stream combination server and user equipment.

The video combination processor may be configured to create the plurality of slice group data by performing at least one of (i) a data size adjustment procedure for each encoded video data such that each encoded video data is displayed at a predetermined screen area on a target display screen; and (ii) a guard area adding procedure for preventing a decoding error due to neighboring slice groups.

In a case that at least one of the plurality of independent video streams is a different single combined video stream, the video combination processor may be configured to extract a plurality of encoded video data in a unit of video frame from the different single combined video stream.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1 illustrates a video advertisement service using a video stream combination in accordance with at least one embodiment;

FIG. 2 is a block diagram illustrating a first video stream combination server in accordance with at least one embodiment;

FIG. 3 is a block diagram illustrating a local video stream combination server in accordance with at least one embodiment;

FIG. 4 illustrates a method of providing a local video advertisement using a video stream combination in accordance with at least one embodiment;

FIG. 5 illustrates a method of performing a video stream combination in accordance with at least one embodiment;

FIG. 6 illustrates another method of performing a video stream combination in accordance with at least one embodiment;

FIG. 7A through FIG. 7C illustrate a mapping relation between video streams and slice groups in accordance with at least one embodiment;

FIG. 8A and FIG. 8B illustrate a concept of a video stream combination which is performed in a unit of frame in accordance with at least one embodiment;

FIG. 9 illustrates a bitstream structure of a single combined video stream in accordance with at least one embodiment;

FIG. 10 illustrates an exemplary user interface for providing a plurality of video streams on a single screen of user equipment in accordance with at least one embodiment; and

FIG. 11A and FIG. 11B illustrate a method of adding a guard area in order to overcome a decoding error at a boundary portion of slice groups in accordance with at least one embodiment.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. The embodiments are described below, in order to explain embodiments of the present invention by referring to the figures.

The present embodiment may create a single combined video stream using a plurality of encoded video data extracted from a plurality of video streams to be combined, without decoding each of the plurality of video streams. Herein, each encoded video data may be considered and processed as a slice group of the single combined video stream. In this case, user equipment may decode the single combined video stream using a single decoder, and thereby displaying a plurality video streams on a single screen without having a plurality of decoders corresponding to the number of video streams. Furthermore, the present embodiment may create a single combined video stream by combining at least one broadcast stream and at least one video advertisement stream (e.g., a local advertisement associated with user characteristics) in a unit of frame. Accordingly, the present embodiment may provide a targeted video advertisement without a change of a typical (or existing) broadcast platform.

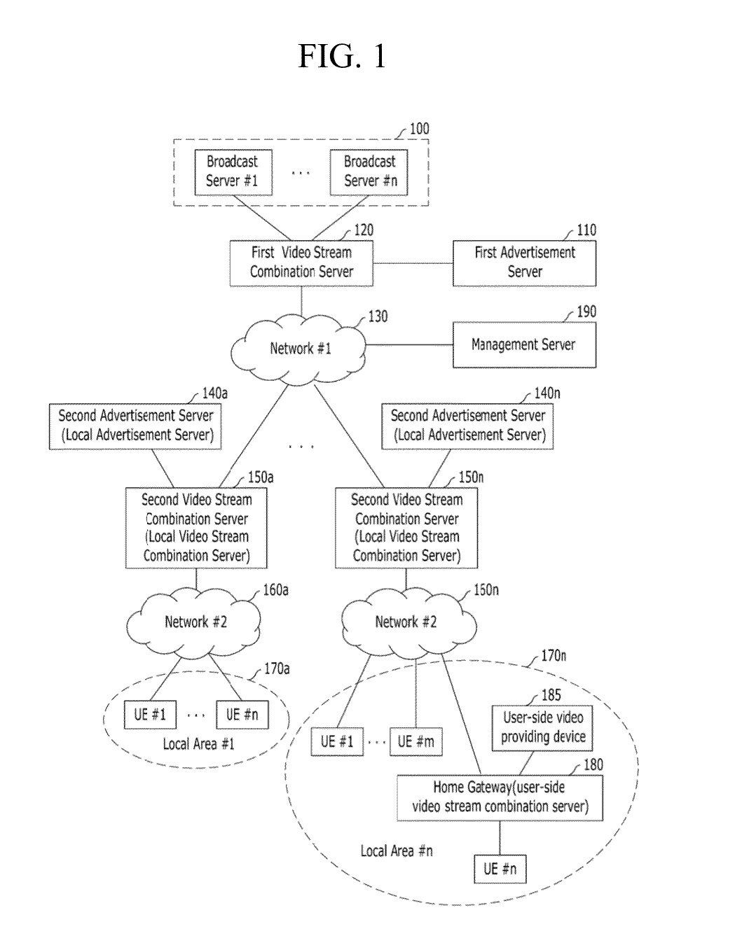

FIG. 1 illustrates interworking between systems for providing a video advertisement using a video stream combination in accordance with at least one embodiment. since the present embodiment is related to a video stream combination, the following description will focus on video streams for convenience.

Referring to FIG. 1, each of at least one broadcast server 100 (e.g., broadcast server #1, . . . , broadcast server #n) may transmit a broadcast stream (e.g., a broadcast transport stream). Herein, the broadcast stream may include a variety of video streams such as a broadcast channel stream, a video on demand (VOD) content stream, an Internet broadcast stream, and so forth. At least one broadcast server 100 may transmit a corresponding broadcast stream through a variety of networks such as a terrestrial broadcast network, a cable broadcast network, a satellite broadcast network, an Internet broadcast network, and so forth. Herein, the broadcast server 100 may be each broadcast station which transmits an original broadcast stream. Alternatively, at least one broadcast server 100 may be a media management center which receives a broadcast steam from the broadcast station and re-transmits the received broadcast stream to a local broadcast server and/or user equipment. In other embodiments, at least one broadcast server 100 may be a service provider server which provides a broadcast service, or a content provider server which provides such multimedia content service as a VOD service. However, the broadcast server 100 is not limited thereto.

First advertisement server 110 (hereinafter referred to as “advertisement server #1”) may provide a variety of advertisement stream (e.g., an advertisement transport stream). Herein, an advertisement stream provided by first advertisement server 110 may be referred to “a first advertisement stream” or “a central advertisement stream.” The first advertisement server 110 may be a server operated by such advertisement content provider as an advertisement manufacturer, an advertisement distributor, and/or an advertiser. In particular, first advertisement server 110 (i.e., advertisement server #1) may provide a common advertisement. Herein, the common advertisement may be an advertisement which can be commonly applied to a variety of users regardless of user characteristics (e.g., a user location, a user age, a user gender, a broadcast viewing history, a broadcast viewing time, a broadcast viewing channel, etc.). Accordingly, in this case, first advertisement server 110 may be referred to as “a common advertisement server.”

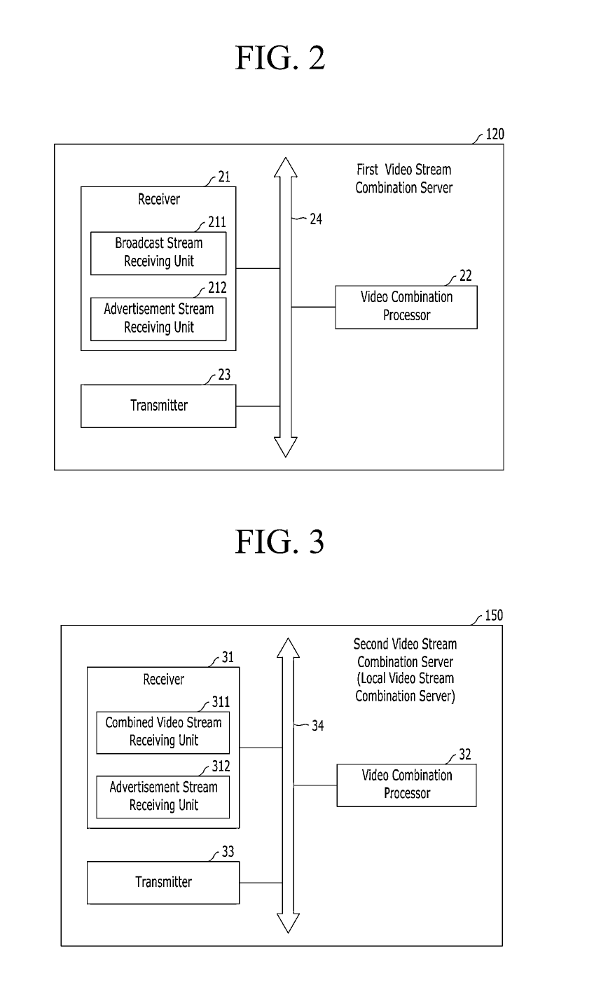

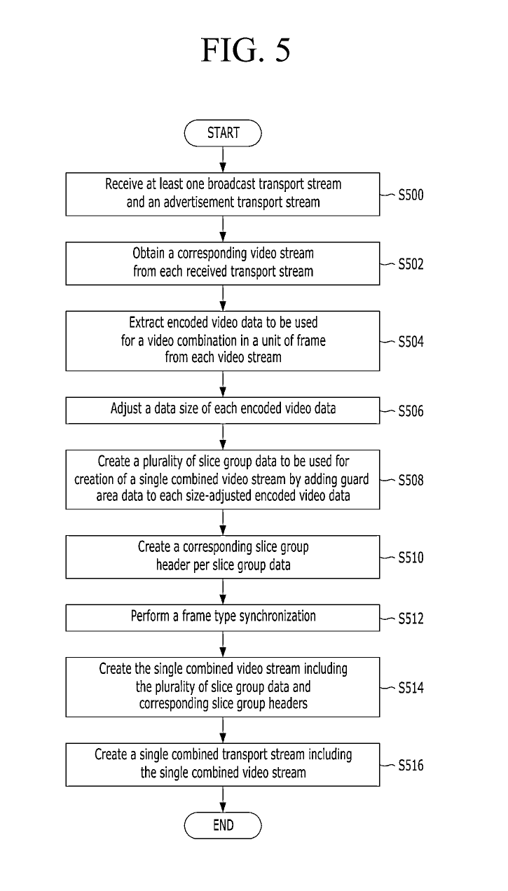

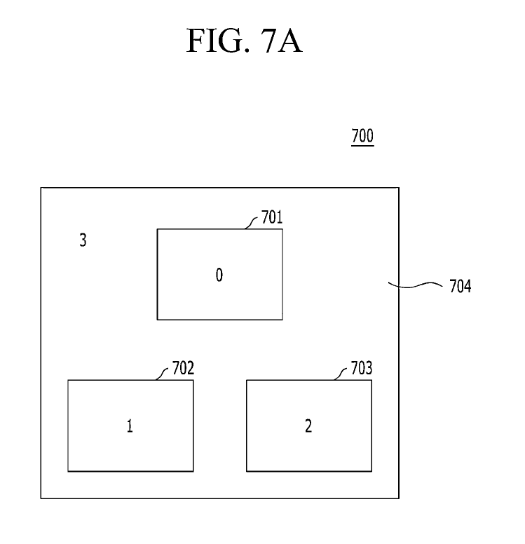

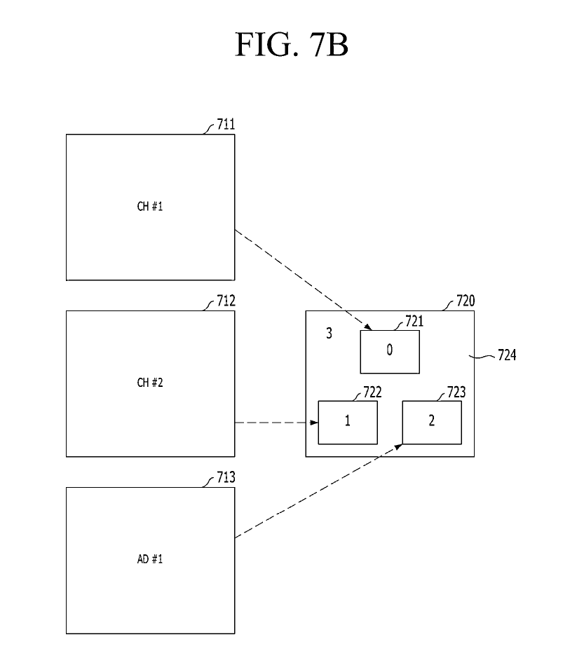

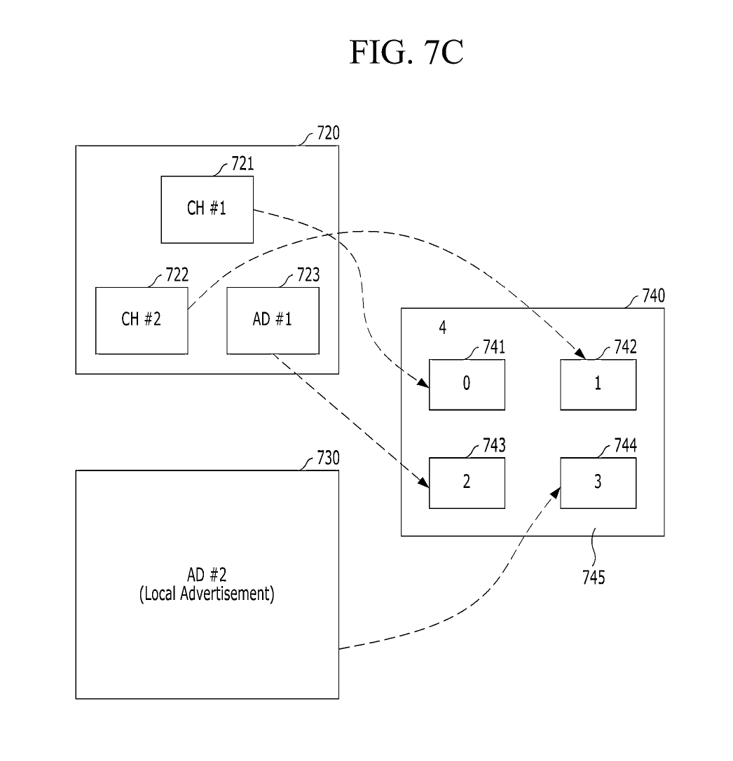

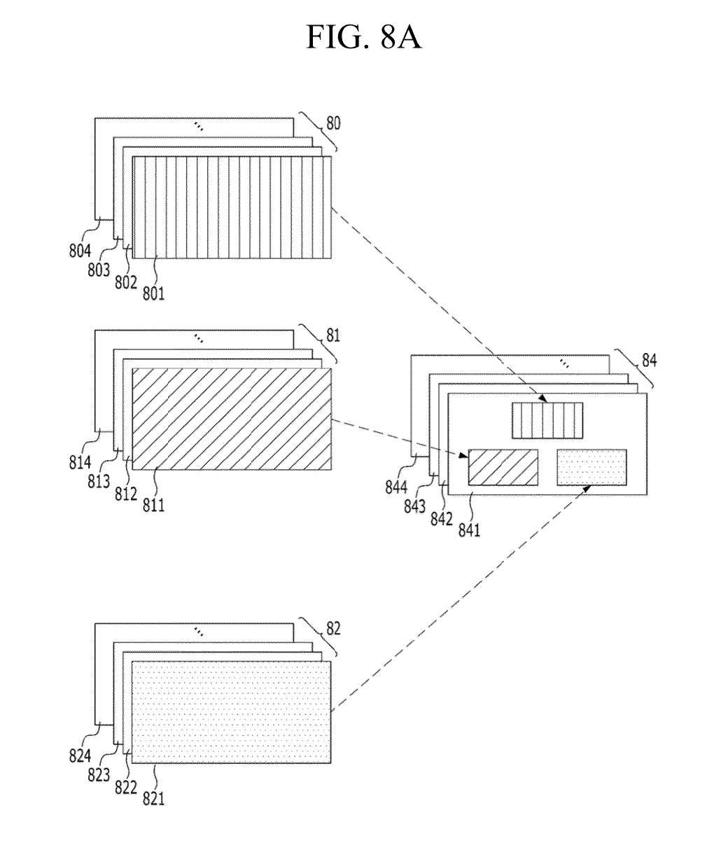

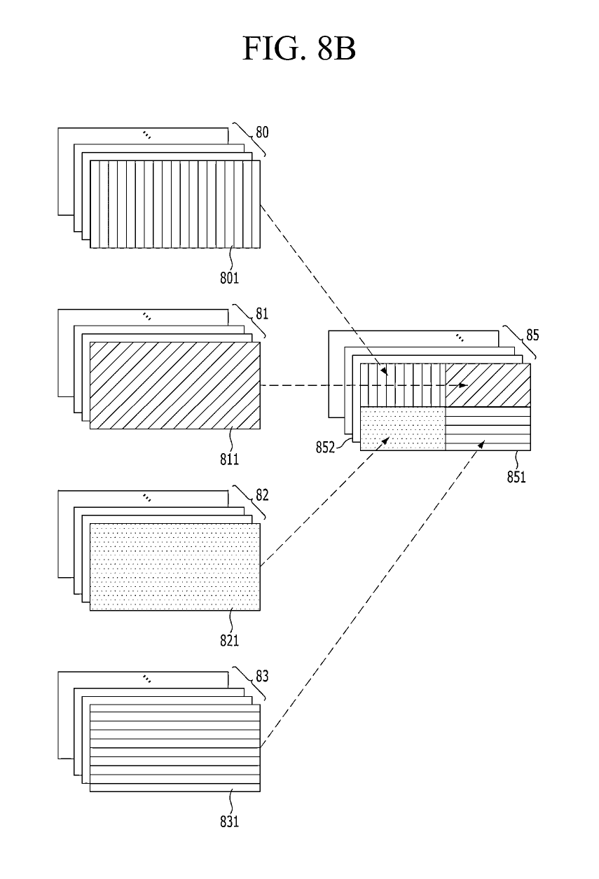

First video stream combination server 120 (hereinafter referred to as “video stream combination server #1” or “central video stream combination server”) may receive at least one broadcast stream (e.g., at least one broadcast transport stream) from at least one broadcast server 100. Furthermore, first video stream combination server 120 may receive the first advertisement stream (e.g., a first video advertisement stream) from first advertisement server 110 (i.e., advertisement server #1). When receiving at least one broadcast stream and the first advertisement stream, first video stream combination server 120 (video stream combination server #1) may create a single combined video stream (hereinafter referred to as “a first single combined video stream”) using the received broadcast stream(s) and first advertisement stream. More specifically, first video stream combination server 120 may create the first single combined video stream using ‘encoded video data’ (i.e., video bitstream) included in each video stream, without performing an image reconstruction through a decoding process of each video stream (i.e., the received broadcast stream(s) and first advertisement stream). In this case, first video stream combination server 120 may create header information (e.g., slice group header information) for each encoded video data (e.g., encoded video data included in at least one broadcast stream, and encoded video data included in a first video advertisement stream) used to create a first single combined video stream. In this case, each encoded video data may be considered and processed as each slice group data. More specifically, first video stream combination server 120 may create the header information based on predetermined screen configuration information of the first single combined video stream. Herein, the predetermined screen configuration information may include a mapping relation of “each video stream” and “a target screen area on a single display screen” (i.e., slice groups). Herein, the header information may include at least one of position information and size information associated with each video stream included in the first single combined video stream. Such video stream combination procedure of first video stream combination server 120 will be described in more detail with reference to FIG. 2, FIG. 4, FIG. 5, FIG. 7A, FIG. 7B, and FIG. 8A to FIG. 11B.

When the first single combined video stream is created, first video stream combination server 120 (“video stream combination server #1”) may transmit the first single combined video stream to one or more second video stream combination servers (e.g., 150a, . . . , 150n) through network #1 (130) (e.g., a backbone network such as Internet). First video stream combination server 120 may transmit the first single combined video stream using a multicast transmission scheme. Herein, the second video stream combination server(s) (e.g., 150a, . . . , 150n) may be referred to as “local video stream combination server(s).” In other embodiments, first video stream combination server 120 may transmit the first single combined video stream to at least one user equipment.

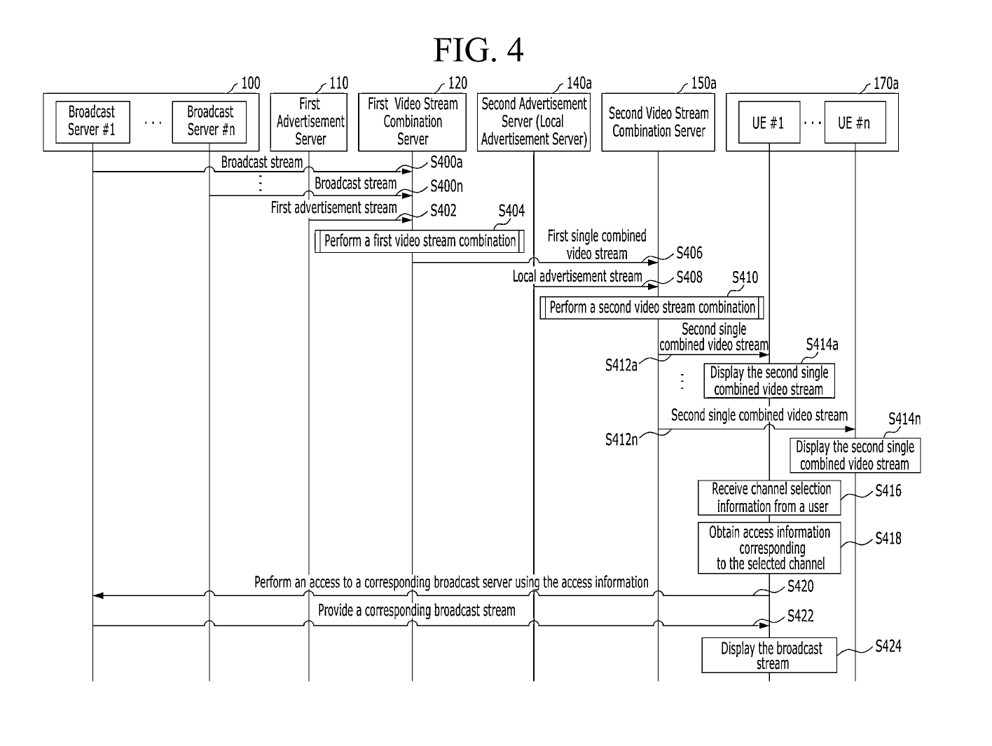

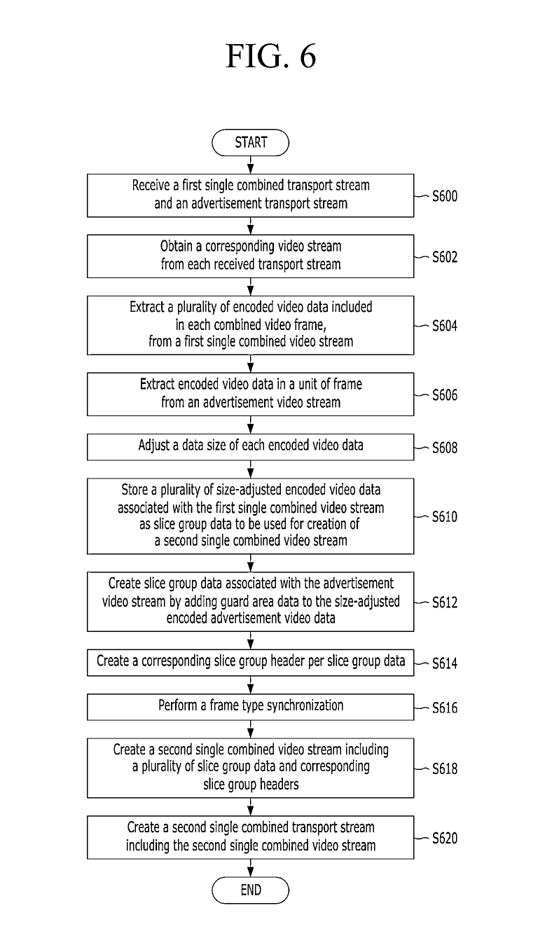

One or more second video stream combination servers (e.g., 150a, . . . , 150n) may receive the first single combined video stream from first video stream combination server 120. The one or more second video stream combination servers (e.g., 150a, . . . , 150n) may be configured in a local node. Furthermore, the second video stream combination server(s) (e.g., 150a, . . . , 150n) may receive a second advertisement stream (e.g., a second video advertisement) from a local advertisement server (e.g., 140a, . . . , 140n) (hereinafter referred to as “advertisement server #2”). Herein, the second advertisement may be a local advertisement stream associated with user characteristics (e.g., a user location, a user age, a user gender, a broadcast viewing history, a broadcast viewing time, a broadcast viewing channel, etc.). When receiving the first single combined video stream and the received second advertisement stream, the second video stream combination server(s) (e.g., 150a, . . . , 150n) may create a second single combined video stream using (i) the received first single combined video stream and (ii) the received second advertisement stream (e.g., the local advertisement stream). Herein, the local advertisement stream may be referred to as “a targeted advertisement stream” to users. More specifically, the second video stream combination server (e.g., 150a, . . . , 150n) may extract a plurality of encoded video data (e.g., encoded video data corresponding to a specific broadcast stream, and encoded video data corresponding to the first advertisement stream) from the first single combined video stream. In a similar manner to the first video combination procedure of first video stream combination server 120, the second video stream combination server (e.g., 150a, . . . , 150n) may create the second single combined video stream using (i) a plurality of encoded video data extracted from the first single combined video stream and (ii) encoded video data extracted from the second (or local) advertisement stream. In this case, the second video stream combination server (e.g., 150a, . . . , 150n) may create header information (e.g., slice group header information) for each encoded video data (e.g., encoded video data included in at least one broadcast stream, encoded video data included in a first video advertisement stream, and encoded video data included in a second video advertisement stream) used to create a second single combined video stream. In this case, each encoded video data may be considered and processed as each slice group data. Such video stream combination procedure of the second video stream combination servers(s) (e.g., 150a, . . . , 150n) will be described in more detail with reference to FIG. 3, FIG. 4, FIG. 6, and FIG. 7C to FIG. 11B. Thereafter, when creating the second single combined video stream, each second video stream combination server (e.g., 150a, . . . , 150n) may transmit the second single combined video stream to one or more user equipment (e.g., UE #1, . . . UE #n in local area #1; UE #1, . . . , UE #m in local area #n) belonging to a corresponding local area [e.g., local area #1 (170a), . . . , local area #n (170n)] through network #2 (e.g., 160a, . . . , 160n) corresponding to a local network. Herein, network #1 and/or network #2 may include a 3rd generation partnership project (3GPP) network, a long term evolution (LTE) network, a world interoperability for microwave access network (WIMAX), Internet, a wireless local area network (LAN), a wide area network (WAN), a personal area network (PAN), a Bluetooth network, a variety of broadcast networks, and/or a cable network, but are not limited thereto. Network #1 and network #2 may be the same or different. In at least one embodiment, network #1 may be a backbone network such as Internet, and network #2 may be an access network. In at least one embodiment, with respect to a transmission scheme, a multicast transmission scheme and a broadcast transmission scheme may be employed in network #1, and a unicast transmission scheme may be employed in network #2.

In at least one embodiment, specific user equipment (e.g., UE #n in local area #n) may be coupled to home gateway 180 corresponding to a user-side video stream combination server. Furthermore, home gateway 180 may be coupled to one or more user-side video providing devices (e.g., 185) such as a CCTV, a user smart phone, and so forth. In this case, home gateway 180 corresponding to the user-side video stream combination server may create a third single combined video stream, using (i) the received second single combined video stream and (ii) one or more video contents provided by user-side video providing device 185. More specifically, home gateway 180 may extract a plurality of ‘encoded video data’ (e.g., encoded video data corresponding to each broadcast stream, encoded video data corresponding to the first advertisement stream, and encoded video data corresponding to the second advertisement stream) from the second single combined video stream. In a similar manner to the second video combination procedure of second video stream combination server 150n, home gateway 180 may create the third single combined video stream using (i) the plurality of encoded video data extracted from the second single combined video stream and (ii) encoded video data corresponding to the video content by provided user-side video providing device 185. In this case, home gateway 180 may create header information for each of the video streams (e.g., at least one broadcast stream, a first video advertisement stream, a second video advertisement stream, and a video stream by provided user-side video providing device 185) used to create a third single combined video stream. Such video stream combination procedure of home gateway 180 will be described in more detail with reference to FIG. 3, FIG. 4, FIG. 6, and FIG. 7C to FIG. 11B. Thereafter, when creating the third single combined video stream, home gateway 180 may transmit the third single combined video stream to user equipment (e.g., UE #n) belonging to a corresponding local area (e.g., local area #n (170n)).

User equipment (e.g., UE #1, . . . , UE #n in local area #1; UE #1, . . . , UE #m in local area #n) may receive the second single combined video stream from a second advertisement server (e.g., 150a, . . . , or 150n). When receiving the second single combined video stream from the second advertisement server, the user equipment may display the second single combined video stream. In this case, a plurality of encoded video data (e.g., encoded video data corresponding to at least one broadcast channel stream, encoded video data corresponding to a first advertisement stream, and encoded video data corresponding to a second (local) advertisement stream) included in the second single combined video stream may be simultaneously displayed on a single screen of the user equipment. Herein, the user equipment may include a device capable of displaying a video stream. For example, the user equipment may include a communication terminal having a display screen, a smart phone, a personal computer system, a set-top box connected to a television (TV), a smart TV, and/or an internet protocol (IP) TV, but is not limited thereto. Alternatively, user equipment may receive the first single combined video stream from first video stream combination server 120, and then display the first single combined video stream.

In other embodiments, user equipment (e.g., UE #n in local area #n) may receive the third single combined video stream from home gateway 180 corresponding to user-side video combination server 185 (e.g., a CCTV). When receiving the second single combined video stream from home gateway 180, the user equipment (e.g., UE #n) may display the third single combined video stream. In this case, as shown in FIG. 10, a plurality of encoded video data (e.g., encoded video data corresponding to at least one broadcast channel stream, encoded video data corresponding to a first advertisement stream, encoded video data corresponding to a second (local) advertisement stream, and encoded video data corresponding to additional video streams provided user-side video providing device 185) included in the second single combined video stream may be simultaneously displayed on a single screen of the user equipment.

In at least one embodiment, management server 190 may be included in order to provide a variety of video streams (e.g., broadcast streams, video advertisement streams) using a video stream combination. Management server 190 may perform a broadcast service subscription management, a subscriber information management, a UI template registration/management, a source access information registration/management, and/or a stream source registration/management. Herein, a stream source may be multimedia contents such as a broadcast content and an advertisement content. The source access information may include broadcast channel information, URL information (e.g., URL of an advertisement server), and so forth. Furthermore, users may access management server 190, receive a variety of user interface (UI) templates associated with a screen configuration of a single combined video stream, and select (or register) at least one UI template. Furthermore, users may change the registered UI template(s) to one or more different/new UI templates. In the case that a specific UI template is selected by a user, a video stream combination server (e.g., 120, 150a, . . . , 150n, or 180) may create a single combined video stream according to screen configuration information corresponding to the selected UI template.

FIG. 2 is a block diagram illustrating a detailed structure of a first video stream combination server in accordance with at least one embodiment. Since the present embodiment is related to a video stream combination, the following description will focus on video streams for convenience.

Referring to FIG. 2, the first video stream combination sever (e.g., 120) according to at least one embodiment may include receiver 21, video combination processor 22, and transmitter 23. Herein, receiver 21, video combination processor 22, and transmitter 23 may be communicatively coupled via bus 24.

Receiver 21 may receive at least one broadcast stream and/or an advertisement stream (i.e., a first advertisement stream). More specifically, receiver 21 may include broadcast stream receiving unit 211 and advertisement stream receiving unit 212. Herein, broadcast stream receiving unit 211 corresponding to sub-processor may receive at least one broadcast stream (e.g., one or more broadcast channel streams corresponding to CH #1, CH #2, . . . , or CH #n) from at least one broadcast server 100. Advertisement stream receiving unit 212 corresponding to sub-processor may receive a first advertisement stream (e.g., a common video advertisement stream) from an advertisement server (e.g., first advertisement server 110).

Video combination processor 22 may create a single combined video stream (“a first single combined video stream”) by combining (i) encoded video data included in the received broadcast stream(s) and (ii) encoded video data included in the received first advertisement stream. More specifically, video combination processor 22 may create the first single combined video stream using ‘encoded video data’ included in each video stream, without performing an image reconstruction through a decoding process of each video stream (i.e., the received broadcast stream(s) and the received first advertisement stream). In at least one embodiment, video combination processor 22 may create a first single combined transport stream (TS) by multiplexing the first single combined video stream and corresponding audio streams. Such video stream combination procedure of video combination processor 22 will be described in more detail with reference to FIG. 4, FIG. 5, FIG. 7A, FIG. 7B, and FIG. 8A to FIG. 11B.

Transmitter 23 may transmit the first single combined video stream created by video combination processor 22, to (i) one or more second video stream combination servers (e.g., 150a, . . . , 150n) and/or (ii) at least one user equipment. More specifically, transmitter 23 may transmit the first single combined video stream to one or more second video stream combination servers (e.g., 150a, . . . , 150n), through a broadcast transmission scheme or a multicast transmission scheme. Transmitter 23 may transmit the first single combined video stream to at least one user equipment, through one of a broadcast transmission scheme, a multicast transmission scheme, and a unicast transmission scheme. Meanwhile, in at least one embodiment, when transmitting the first single combined video stream to a second video stream combination server (e.g., 150a, . . . , or 150n) and/or user equipment, transmitter 23 may establish a session in connection with the second video stream combination server and/or the user equipment, according to a real time streaming protocol (RTSP). In the case that the first single combined transport stream (TS) is created by video combination processor 22, transmitter 23 may transmit the first single combined transport stream (TS) to one or more second video stream combination servers (e.g., 150a, . . . , 150n) and/or at least one user equipment.

FIG. 3 is a block diagram illustrating a detailed structure of a local video stream combination server (i.e., a second video stream combination server) in accordance with at least one embodiment. Since the present embodiment is related to a video stream combination, the following description will focus on video streams for convenience.

Referring to FIG. 3, the local video stream combination sever (e.g., 150a, . . . , or 150n) according to at least one embodiment may include receiver 31, video combination processor 32, and transmitter 33. Herein, receiver 31, video combination processor 32, and transmitter 33 may be communicatively coupled via bus 34.

Receiver 31 may receive a first single combined video stream (e.g., a single combined video stream created by first video stream combination server 120 in FIG. 2) and/or a second advertisement stream (e.g., a local advertisement stream). More specifically, receiver 31 may include combined video stream receiving unit 311 and advertisement stream receiving unit 312. Herein, combined video stream receiving unit 311 corresponding to sub-processor may receive the first single combined video stream from first video stream combination server 120. Particularly, combined video stream receiving unit 311 may receive the first single combined video stream through a single session. In the case that the first video stream combination server (e.g., 120) transmits a first single combined transport stream (TS), combined video stream receiving unit 311 may receive the first single combined transport stream (TS). Advertisement stream receiving unit 312 corresponding to sub-processor may receive a second advertisement stream (e.g., a local advertisement transport stream) from an advertisement server (e.g., second advertisement server 140a, . . . , or 140n).

Video combination processor 32 may create a single combined video stream (“a second single combined video stream”) using (i) the received first single combined video stream and (ii) the received second advertisement stream (e.g., the local advertisement stream). More specifically, video combination processor 32 may extract a plurality of encoded video data (e.g., encoded broadcast video data extracted from broadcast streams, and/or encoded advertisement video data extracted from the first advertisement stream) from the first single combined video stream. The video combination processor 32 may create the second single combined video stream, using (i) a plurality of encoded video data extracted from the first single combined video stream and (ii) encoded video data extracted from the second (or local) advertisement stream. In at least one embodiment, video combination processor 32 may create a second single combined transport stream (TS) by multiplexing the second single combined video stream, corresponding audio streams, and/or additional information. Such video stream combination procedure of the video combination processor 32 will be described in more detail with reference to FIG. 4, FIG. 6 and FIG. 7C to FIG. 11B.

Transmitter 33 may transmit the second single combined video stream to one or more user equipment (e.g., UE #1, . . . UE #n in local area #1; UE #1, . . . , UE #m in local area #n) belonging to a corresponding local area [e.g., local area #1 (170a), . . . , local area #n (170n)]. Transmitter 33 may transmit the second single combined video stream to one or more user equipment, through a unicast transmission scheme. Alternatively, transmitter 33 may transmit the second single combined video stream to one or more user equipment, through a broadcast transmission scheme or a multicast transmission scheme. In the case that the second single combined transport stream (TS) is created by video combination processor 32, transmitter 33 may transmit the second single combined transport stream (TS).

In other embodiments, transmitter 33 may transmit the second single combined video stream to home gateway 180 corresponding to a user-side video stream combination server. In this case, transmitter 33 may transmit the second single combined video stream to home gateway 180, through one of a broadcast transmission scheme, a multicast transmission scheme, and a unicast transmission scheme. Meanwhile, in at least one embodiment, when transmitting the second single combined video stream to user equipment and/or home gateway 180, transmitter 33 may establish a session in connection with the user equipment and/or home gateway 180, according to a real time streaming protocol (RTSP).

Meanwhile, a structure of the local video stream combination server 150 (i.e., video stream combination server #2) may be similarly applied to home gateway 180 corresponding to user-side video combination server 185 (e.g., a CCTV). In other words, home gateway 180 corresponding to user-side video combination server 185 may include a receiver corresponding to receiver 31, a video combination processor corresponding to video combination processor 32, and a transmitter corresponding to transmitter 33. Herein, the receiver of home gateway 180 may include (i) a combined video stream receiving unit which receives a second single combined video stream (i.e., a local single combined video stream), and/or (ii) an additional video stream receiving unit which receives one or more additional video streams provided user-side video providing device 185. In other embodiments, the additional video stream receiving unit may receive an additional video content from user-side video providing device 185. In this case, the additional video stream receiving unit may create a video stream by encoding the received additional video content.

The video combination processor of home gateway 180 may create a third single combined video stream, using (i) a plurality of encoded video data extracted from the received second single combined video stream and (ii) one or more encoded video data extracted from one or more video content streams provided by user-side video providing device 185. More specifically, the video combination processor of home gateway 180 may extract a plurality of ‘encoded video data’ (e.g., encoded broadcast video data extracted from each broadcast stream, encoded advertisement video data extracted from the first advertisement stream, encoded advertisement video data extracted from the second (or local) advertisement stream) from the second single combined video stream. The video combination processor of home gateway 180 may create the third single combined video stream using (i) the extracted encoded video data and (ii) encoded video data extracted from video content stream provided by user-side video providing device 185.

FIG. 4 illustrates a method of providing a local video advertisement using a video stream combination in accordance with at least one embodiment. Since the present embodiment is related to a video stream combination, the following description will focus on video streams for convenience.

Referring to FIG. 4, at steps S400a through S400n, one or more broadcast server 100 (e.g., broadcast server #1, . . . , broadcast server #n) may transmit at least one or more broadcast streams (e.g., broadcast transport streams). Herein, the broadcast streams may be a variety of video streams such as a broadcast channel stream, a video on demand (VOD) content stream, an Internet broadcast stream, and so forth. For example, in the case that one or more broadcast server 100 are associated with broadcast channels, broadcast server #1 may transmit a broadcast stream associated with a first broadcast channel (i.e., CH #1), and broadcast server #n may transmit a broadcast stream associated with an n^{th} broadcast channel (i.e., CH #n).

At step S402, first advertisement server 110 (i.e., advertisement server #1) may provide a variety of first advertisement streams (e.g., first advertisement transport streams). In particular, first advertisement server 110 (i.e., advertisement server #1) may provide a common advertisement. Herein, the common advertisement may be an advertisement which can be commonly applied to a variety of users regardless of user characteristics (e.g., a user location, a user age, a user gender, a broadcast viewing history, a broadcast viewing time, a broadcast viewing channel, etc.).

As described above, first video stream combination server 120 may receive at least one broadcast stream from at least one broadcast server 100. Furthermore, first video stream combination server 120 may receive the first advertisement stream (e.g., a common advertisement) from first advertisement server 110 (i.e., advertisement server #1). At step S404, first video stream combination server 120 may create a first single combined video stream using the received broadcast stream(s) and the received first advertisement stream. More specifically, first video stream combination server 120 may create the first single combined video stream using “encoded video data” included in each video stream, without performing an image reconstruction through a decoding process of each video stream (i.e., the received broadcast stream(s) and first advertisement stream). Such video stream combination procedure (“S404”) of first video stream combination server 120 will be described in more detail with reference to FIG. 5, FIG. 7A, FIG. 7B, and FIG. 8A to FIG. 11B.

At step S406, first video stream combination server 120 (i.e., video stream combination server #1) may transmit the first single combined video stream to one or more second video stream combination servers (e.g., 150a, . . . , 150n). With respect to FIG. 4, for convenience of descriptions, it will be described a case that the first single combined video stream is transmitted to a second video stream combination server (e.g., 150a). More specifically, as described in FIG. 5 later, first video stream combination server 120 (i.e., video stream combination server #1) may create a first single combined transport stream (TS) by multiplexing the first single combined video stream and corresponding audio streams. In this case, first video stream combination server 120 may transmit the first single combined transport stream (TS) to the second video stream combination server (e.g., 150a).

At step S408, a second video stream combination server (e.g., 150a) may provide a second advertisement stream (e.g., a second advertisement transport stream) to the second video stream combination server (e.g., 150a). Herein, the second video stream combination server (e.g., 150a) may be a local video stream combination server. In this case, the second advertisement stream may be referred to as “a local advertisement stream.”

At step S410, the second video stream combination server (e.g., 150a) may create a second single combined video stream using (i) the received first single combined video stream and (ii) the received second advertisement stream (e.g., the local advertisement stream). More specifically, the second video stream combination server (e.g., 150a) may extract a plurality of encoded video data (e.g., encoded broadcast video data associated with at least one broadcast video stream, encoded advertisement video data associated with the first advertisement video stream) from the first single combined video stream. The second video stream combination server (e.g., 150a) may create the second single combined video stream using (i) a plurality of encoded video data extracted from the first single combined video stream and (ii) encoded video data extracted from the second advertisement stream (i.e., a local advertisement stream). Such video stream combination procedure (“S410”) of the second video stream combination servers (e.g., 150a) will be described in more detail with reference to FIG. 6 and FIG. 7C.

At steps S412a through S412n, when creating the second single combined video stream, the second video stream combination server (e.g., 150a) may transmit the second single combined video stream to one or more user equipment (e.g., UE #1, . . . UE #n in local area #1) belonging to a corresponding local area (e.g., local area #1 (170a)). More specifically, as described in FIG. 6 later, second video stream combination server 150a (i.e., a local video stream combination server) may create a second single combined transport stream (TS) by multiplexing the second single combined video stream and corresponding audio streams. In this case, second video stream combination server 150a may transmit the second single combined transport stream (TS) to at least one user equipment (e.g., UE#1, . . . , UE #n).

At steps S414a through S414n, when receiving the second single combined video stream from the second video stream combination server (e.g., 150a), each user equipment (e.g., UE #1, . . . , or UE #n) may display the received second single combined video stream. In this case, a plurality of video streams (e.g., at least one broadcast channel stream, a first advertisement stream, and a second (local) advertisement stream) included in the second single combined video stream may be simultaneously displayed on a single screen of each user equipment.

At step S416, each user equipment (e.g., UE #1) may receive a user selection for a specific video stream (e.g., a broadcast channel stream such as CH #1 to CH #N, or an advertisement stream). For example, user equipment (e.g., UE #1) may receive a user selection for a specific broadcast channel stream (e.g., CH #1).

At step S418, when receiving the user selection for a specific broadcast channel, corresponding user equipment (e.g., UE #1) may obtain access information (e.g., a broadcast channel number or a uniform resource locator (URL)) of a broadcast server corresponding to the selected broadcast channel. Herein, in the case that the second single combined transport stream (TS) is received from second video stream combination server 150a, user equipment (e.g., UE #1) may obtain the access information from a program map table (PMT) as shown in [Table 1]. Alternatively, the user equipment (e.g., UE #1) may obtain the access information from management server 190.

At step S420, when obtaining the access information, the corresponding user equipment (e.g., UE #1) may perform an access to a corresponding broadcast server (e.g., broadcast server #1) using the access information, and transmit a request for the selected broadcast stream to a corresponding broadcast server (e.g., broadcast server #1).

At step S422, when receiving the request for the selected broadcast stream form the corresponding user equipment (e.g., UE #1), the corresponding broadcast server (e.g., broadcast server #1) may provide a corresponding broadcast stream to the corresponding user equipment (e.g., UE #1).

At step S424, when receiving the corresponding broadcast stream from the corresponding broadcast server (e.g., broadcast server #1), the corresponding user equipment (e.g., UE #1) may display the received broadcast stream on an entire screen of the corresponding user equipment (e.g., UE #1).

FIG. 5 illustrates a method of performing a video stream combination in accordance with at least one embodiment. In other words, FIG. 5 illustrates (i) a video stream combination procedure (e.g., a video stitching procedure) performed in first video stream combination server 120 of FIG. 2, and (ii) a first video stream combination procedure of step S404.

Referring to FIG. 5, at step S500, a video stream combination server (e.g., first video stream combination server 120) may receive at least one broadcast stream (e.g., at least one broadcast transport stream) and an advertisement stream (e.g., a first advertisement transport stream). Herein, the broadcast stream (e.g., broadcast transport stream) and/or the advertisement stream (e.g., a first advertisement transport stream) may include video stream, audio stream, and/or additional data. Furthermore, the broadcast stream (e.g., broadcast transport stream) may include metadata associated with a broadcast video stream and/or a corresponding broadcast content. The advertisement stream (e.g., a first advertisement transport stream) may include metadata associated with an advertisement video stream and/or a corresponding advertisement content. Herein, the metadata may include attribute information such as a screen resolution, a bit rate, a frame rate, and/or attributes of original video sources corresponding to video streams. Such metadata may be considered (or used) when a single combined video stream is created.

More specifically, the video stream combination server (e.g., first video stream combination server 120) may receive the at least one broadcast stream (e.g., at least one broadcast transport stream) from at least one broadcast server 100 (e.g., broadcast server #1, . . . , broadcast server #n). Furthermore, the video stream combination server (e.g., first video stream combination server 120) may receive the advertisement stream (e.g., the first advertisement transport stream) from an advertisement server (e.g., first advertisement server 110). Herein, the advertisement stream may be a common advertisement stream which can be commonly applied to a variety of users regardless of user characteristics (e.g., a user location, a user age, a user gender, a broadcast viewing history, a broadcast viewing time, a broadcast viewing channel, etc.).

At step S502, the video stream combination server may obtain a corresponding video stream from each received transport stream. More specifically, the video stream combination server may obtain a corresponding broadcast video stream from each of the received at least one broadcast stream (e.g., at least one broadcast transport stream) by performing a de-multiplexing process. For example, in the case that broadcast transport stream #1 associated with CH #1 and broadcast transport stream #2 associated with CH #2 are received, the video stream combination server may obtain broadcast video stream #1 from broadcast transport stream #1, and obtain broadcast video stream #2 from broadcast transport stream #2. Furthermore, the video stream combination server may obtain an advertisement video stream from the received advertisement stream (e.g., the first advertisement transport stream).

At step S504, the video stream combination server may extract ‘encoded video data’ (i.e., encoded video bitstream data) to be used for a video combination, in a unit of frame from each video stream (e.g., broadcast video streams or an advertisement video stream). More specifically, the video stream combination server may extract the encoded video data from each video stream, through a data parsing process without performing an image reconstruction (e.g., decoding) procedure. For example, the video stream combination server may extract ‘corresponding encoded broadcast video data’ included in each broadcast video stream, and extract ‘encoded advertisement video data’ included in the advertisement video stream. Herein, a procedure of extracting the encoded video data may be performed in a unit of video frame.

At step S506, the video stream combination server may adjust a data size of each encoded video data. That is, the video stream combination server may perform a data size adjustment for each encoded video data extracted at step S504 such that each video stream (e.g., 711, 712, 713 in FIG. 7B) is displayed at a predetermined screen area (e.g., 721, 722, 723 in FIG. 7B) on a target display screen. Herein, the data size adjustment may be performed through a transcoder. More specifically, as shown in FIG. 7A and FIG. 7B, the video stream combination server may reduce a data size of each encoded video data according to a mapping relation of ‘each video stream’ (e.g., 711, 712, 713) and ‘a target screen area (e.g., 721, 722, 723) on a single display screen (720).’

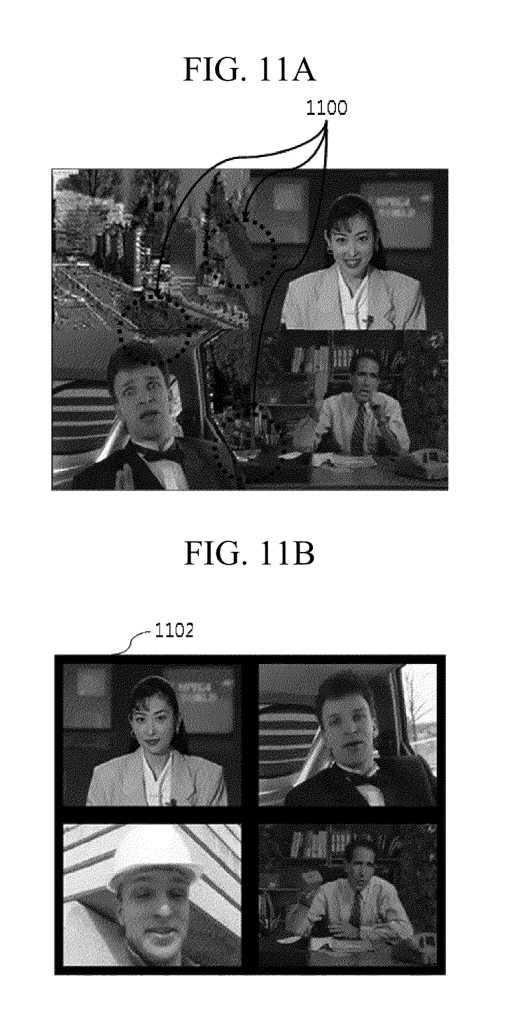

At step S508, the video stream combination server may create a plurality of slice group data to be used for creation of a single combined video stream by adding guard area data to each size-adjusted encoded video data. Such procedure of adding a guard area will be described in more detail with reference to FIG. 11A and FIG. 11B. In other embodiment, in the case that such procedure of adding a guard area is not performed, each size-adjusted encoded video data (“S506”) may correspond to the slice group data to be used for creation of a single combined video stream.

At step S510, the video stream combination server may create a corresponding slice group header per slice group data. More specifically, the video stream combination server may create position information (i.e., information on a position of a corresponding slice group in a corresponding combined frame) for each slice group data such that each video stream (e.g., 711, 712, 713 in FIG. 7B) is displayed at a predetermined screen area (e.g., 721, 722, 723 in FIG. 7B) on a target display screen. Herein, the position information of each slice group data may be determined in a unit of macroblock. In other words, the video stream combination server may create position information for each slice group data according to a mapping relation of ‘each video stream’ (e.g., 711, 712, 713) and ‘a target screen area (e.g., 721, 722, 723) on a single display screen (720).’ Herein, the position information may be used as a slice header when creating a first single combined video stream. In other embodiments, the slice group header may further include size information of each slice group.

At step S512, the video stream combination server may perform a frame type synchronization. More specially, the video stream combination server may perform the frame type synchronization such that same type frames (e.g., P frame, I frame) are combined for a creation of a single combined video stream.

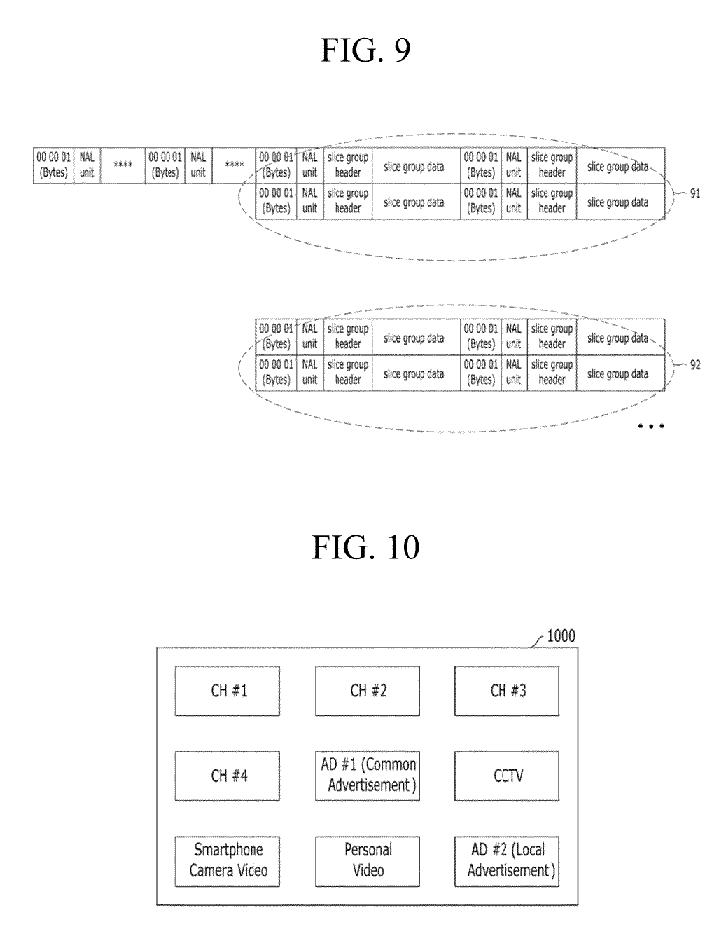

At step S514, the video stream combination server may create the single combined video stream including the plurality of slice group data and corresponding slice group header. In other words, the video stream combination server may create the single combined video stream using concepts of “slice group” and “slice group header” used in a flexible macroblock ordering (FMO) technique. In particular, each encoded video data extracted from each video stream (e.g., “711,” “712,” or “713” in FIG. 7B) may be considered and processed as ‘slice group data’ corresponding to the same slice group (e.g., “slice group 0,” “slice group 1,” or “slice group 2” in FIG. 7B). Such procedure of creating the single combined video stream will be described in more detail with reference to FIG. 8 A, FIG. 8B, and FIG. 9.

Furthermore, the number of video frames of a plurality of video streams to be combined may be different each other. In this case, the video stream combination server may create a single combined video stream by repetitively using a specific frame (e.g., the last frame) of a video stream having less frames.

At step S516, the video stream combination server may create a single combined transport stream (TS) (e.g., a first single combined TS) including the single combined video stream. Herein, the single combined transport stream may include the single combined video stream, a plurality of audio streams, and/or additional data (e.g., metadata). The plurality of audio streams may be audio data extracted from each transport stream received at step S500. For example, in the case that the first single combined video stream is created using three video streams associated with CH #1, CH #2, and AD #1 as shown in FIG. 7B, three audio streams associated with CH #1, CH #2, and AD #1 may be included in the first single combined transport stream (TS).

In at least one embodiment, the metadata may include ‘screen configuration information (e.g., configuration information associated with deployment of each broadcast stream) and/or additional information associated with the first single combined video stream and/or corresponding audio streams. For example, the metadata may include a UI template (e.g., a UI template associated with a background image) and/or template configuration information. The metadata may include attribute information (e.g., a screen resolution, a bit rate, a frame rate, and so forth) associated with the first single combined video stream. Such metadata may be used when a single combined video stream is displayed.

Furthermore, the metadata may include access information (e.g., channel numbers, URL) of corresponding content providing servers (e.g., a broadcast server or an advertisement server) which provide video streams included in the first single combined video stream. In other embodiments, the metadata may further include access information of a third party server providing a variety of additional information associated with the first single combined video stream.

The metadata may be included in a program map table (PMT) of the single combined transport stream (TS). In this case, the metadata may be included in the PMT using a private descriptor shown in [Table 1] below, or a data PID. Alternatively, the metadata may be transmitted using H.264 supplemental enhancement information (SEI).

TABLE 1

| | No. of | |
|---|---|---|
| Syntax | bits | Mnemonic |
| TS_program_map_section( ) { | | |
| table_id | 8 | uimsbf |
| section_syntax_indicator | 1 | bslbf |
| ‘0’ | 1 | bslbf |
| reserved | 2 | bslbf |
| section_length | 12 | uimsbf |
| program_number | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| reserved | 3 | bslbf |
| PCR_PID | 13 | uimsbf |
| reserved | 4 | bslbf |
| program_info_length | 12 | uimsbf |
| private_descriptor( ) | | |
| { | | |
| descriptor_tag | 8 | uimsbf |
| descriptor_length | 8 | uimsbf |
| for (i=0;i<9;i++) { | | |
| ch_num (channel number) | 24 | uimsbf (unsigned |
| or Unicast URL (advertisement | | char 3 bytes) |
| server) | | |
| Top-Left Position_X | 16 | uimsbf |
| Top-Left Position_Y | 16 | uimsbf |
| Bottom-Right Position_X | 16 | uimsbf |
| Bottom-Right Position_Y | 16 | uimsbf |
| } | | |
| } | | |
| for (i=0;i<N1;i++) { | | |
| stream_type | 8 | uimsbf |
| reserved | 3 | bslbf |
| elementary_PID | 13 | uimsnf |
| reserved | 4 | bslbf |
| ES_info_length | 12 | uimsbf |
| } | | |
| CRC_32 | 32 | rpchof |
| } | | |

In other embodiments, in the case that the single combined video stream is transmitted through a first session, the video stream combination server may transmit metadata associated with the first single combined video stream through a different session (e.g., a second session) from the first session.

In other embodiments, a content providing server (e.g., a broadcast server or an advertisement server) and/or a transcoding server may perform in advance a data size adjustment procedure and a guard area adding procedure for each video stream to be combined to create a single combined video stream. More specifically, the content providing server and/or the transcoding server may perform in advance a transcoding procedure associated with at least one content stream (e.g., one ore more broadcast transport streams, and/or one or more advertisement transport stream) used for creation of a single combined stream. Particularly, the content providing server and/or the transcoding server may perform a size adjustment (e.g., a resolution change) for the at least one content stream such that each content stream is displayed at a predetermined screen area on a target display screen. Furthermore, the content providing server and/or the transcoding server may add guard area data to each size-adjusted video data. In the case that a video stream combination server receives the transcoded content streams, the video stream combination server may omit the data size adjustment operation (“S506”) and/or the guard area adding operation (“S508”).

FIG. 6 illustrates another method of performing a video stream combination in accordance with at least one embodiment. More specifically, FIG. 6 illustrates (i) a video stream combination procedure performed in second video stream combination server 150a, . . . , or 150n (i.e., a local video stream combination server), and (ii) a second video stream combination procedure of step S410.

Referring to FIG. 6, since the procedures of the present embodiment are similar to those of the embodiment described with reference to FIG. 5, the following description will focus on differences therebetween for convenience.

At step S600, a video stream combination server (e.g., second video stream combination server 150a, . . . , or 150n) may receive a single combined transport stream (e.g., a first single combined transport stream created in FIG. 5) and an advertisement transport stream. Herein, the single combined transport stream and/or the advertisement transport stream may include video stream, audio stream, and/or additional data.

More specifically, the video stream combination server (e.g., second video stream combination server 150a, . . . , or 150n) may receive the single combined transport stream from another video stream combination server (e.g., first video stream combination server 120). Furthermore, the video stream combination server (e.g., second video stream combination server 150a, . . . , or 150n) may receive the advertisement transport stream (e.g., the second advertisement transport stream) from the advertisement server (e.g., second advertisement server 140a, . . . , or 140n). Herein, the second advertisement transport stream may be a local advertisement stream determined according to user characteristics (e.g., a user location, a user age, a user gender, a broadcast viewing history, a broadcast viewing time, a broadcast viewing channel, etc.).

At step S602, the video stream combination server may obtain a corresponding video stream from each received transport stream. More specifically, the video stream combination server may obtain a corresponding single combined video stream (i.e., a first single combined video stream) from the received single combined transport stream (e.g., the first single combined transport stream) by performing a de-multiplexing process. Furthermore, the video stream combination server may obtain an advertisement video stream from the received advertisement transport stream (e.g., the second advertisement transport stream).

At step S604, the video stream combination server may extract a plurality of encoded video data included in each combined video frame, from the first single combined video stream. More specifically, the video stream combination server may extract the plurality of encoded video data from the first single combined video stream, through a data parsing process without performing an image reconstruction (e.g., decoding) procedure. For example, in the case that the first single combined video stream is created by combining three video streams as shown in FIG. 7B, the video stream combination server may extract (i) encoded broadcast video data associated with CH #1, (ii) encoded broadcast video data associated with CH #2, and (iii) encoded advertisement video data associated with AD #1, from the first single combined video stream. Herein, a procedure of extracting the encoded video data may be performed in a unit of video frame.

At step S606, the video stream combination server may extract encoded video data in a unit of frame from the advertisement video stream (e.g., second advertisement server 140a, . . . , or 140n).

At step S608, the video stream combination server may adjust a data size of each encoded video data. That is, the video stream combination server may perform a data size adjustment for each encoded video data extracted at steps S604 and S606 such that each video stream (e.g., 721, 722, 723, 730 in FIG. 7C) is displayed at a predetermined screen area (e.g., 741, 742, 743, 744 in FIG. 7C) on a target display screen. Herein, the data size adjustment may be performed through a transcoder. More specifically, as shown in FIG. 7C, the video stream combination server may reduce a data size of each encoded video data according to a mapping relation of ‘each video stream’ (e.g., 721, 722, 723, 730) and ‘a target screen area (e.g., 741, 742, 743, 744) on a single display screen (740).’ In other embodiments, in the case that a plurality of encoded video data (e.g., encoded video data associated with 721, 722, and 723 in FIG. 7C) extracted from the first single combined video stream have a suitable data size to create a second single combined video stream, a data size adjustment for the plurality of encoded video data (e.g., encoded video data associated with 721, 722, and 723 in FIG. 7C) extracted from the first single combined video stream may not be performed.

At step S610, the video stream combination server may store a plurality of size-adjusted encoded video data associated with the first single combined video stream as slice group data to be used for creation of a second single combined video stream. Herein, the plurality of size-adjusted encoded video data may be considered and processed as slice group data when creating a second single combined video stream. As described at step S508 in FIG. 5, in the case that the plurality of encoded video data (e.g., encoded video data associated with 721, 722, and 723 in FIG. 7C) extracted from the first single combined video stream includes a guard area data, a guard area adding operation for the encoded video data extracted from the first single combined video stream may not be performed.

Meanwhile, at step S612, the video stream combination server may create slice group data associated with the advertisement video stream (e.g., the second advertisement video stream) by adding guard area data to the size-adjusted encoded advertisement video data.

At step S614, the video stream combination server may create a corresponding slice group header per slice group data. More specifically, the video stream combination server may create position information for each slice group data such that each video stream (e.g., 721, 722, 723, 730 in FIG. 7C) is displayed at a predetermined screen area (e.g., 741, 742, 743, 744 in FIG. 7C) on a target display screen. In other words, the video stream combination server may create position information for each slice group data according to a mapping relation of ‘each video stream’ (e.g., 721, 722, 723, 730) and ‘a target screen area (e.g., 741, 742, 743, 744) on a single display screen (740).’ Herein, the position information may be used as a slice header when creating a second single combined video stream. In other embodiments, the slice group header may further include size information of each slice group.

At step S616, the video stream combination server may perform a frame type synchronization. More specially, the video stream combination server may perform the frame type synchronization such that same type frames (e.g., P frame, I frame) are combined for a creation of a single combined video stream.

At step S618, the video stream combination server may create a second single combined video stream including a plurality of slice group data and corresponding slice group headers. In other words, as described in FIG. 5, the video stream combination server may create the second single combined video stream, using concepts of “slice group” and “slice group header” used in a flexible macroblock ordering (FMO) technique. In particular, each encoded video data (e.g., a plurality of encoded video data corresponding to CH #1, CH #2, AD #1, and AD #2) extracted from each video stream (e.g., “720” or “730” in FIG. 7C) may be considered and processed as ‘slice group data’ corresponding to the same slice group (e.g., slice group 0, slice group 1, slice group 2, or slice group 3 in FIG. 7C).

At step S620, the video stream combination server may create a second single combined transport stream (TS) including the second single combined video stream. Herein, the second single combined transport stream may include the second single combined video stream, a plurality of audio streams, and/or metadata. The plurality of audio streams may be audio data extracted from each transport stream received at step S600. For example, in the case that the second single combined video stream is created using four video data associated with CH #1, CH #2, AD #1, and AD #2 as shown in FIG. 7C, four audio streams associated with CH #1, CH #2, AD #1, and AD #2 may be included in the first single combined transport stream (TS).

In other embodiments, second advertisement server (e.g., 140a, . . . , or 140n) may perform in advance a data size adjustment procedure and a guard area adding procedure for a second advertisement video stream to be combined to create a second single combined video stream. In this case, the video stream combination server may not perform the data size adjustment operation (“S608”) and/or the guard area adding operation (“S612”).

FIG. 7A through FIG. 7C illustrate a mapping relation between video streams and slice groups in accordance with at least one embodiment. In other words, FIG. 7A through FIG. 7C illustrate a method of mapping a plurality of video streams to a plurality slice groups.

In a typical H.264/AVC FMO technique, in order to prevent a transmission error, a picture may be partitioned into a plurality of slice groups, and each slice group may be separately encoded. A video stream combination (e.g., a video stitching) according to the present embodiment may be performed by using a concept of slice groups in a FMO technique.

Referring to FIG. 7A, a single combined video stream may include a plurality of slice groups. More specifically, a single combined video stream may be formed by inversely applying a concept of slice group used in the FMO technique. In other words, each of a plurality of broadcast streams to be combined into a single video stream may be mapped to each slice group. For example, as shown in FIG. 7A, a single video stream (e.g., “700”) created through a vide combination procedure may be formed by four slice groups such as “slice 0” through “slice 3.” Herein, “701” through “704” represent “slice group 0,” “slice group 1,” “slice group 2,” and “slice group 3,” respectively. Slice group 3 (“704”) may be referred to as a background group. As shown in FIG. 7A, a shape of slice groups may be a square or rectangular shape according to FMO type 2 (“foreground with leftover”), but is not limited thereto. With respect to a single combined video stream, the number of slice groups may increase or decrease according to an addition or deletion of video streams. Furthermore, the position and/or size of slice groups may be determined or changed according to at least one of (i) the number of video streams to be combined, (ii) a predetermined screen configuration information, (iii) a user selection, and (iv) stream viewing rates. Furthermore, a variety of UI templates may be provided to users such that the users can select a screen structure of the single combined video stream.

Referring to FIG. 7B, a first video stream combination server (e.g., 120) may create a first single combined video stream (e.g., 720) by combining a plurality of video streams (e.g., video streams 711 to 713). More specifically, the first video stream combination server (e.g., 120) may create the first single combined video stream (e.g., 720) by deploying a plurality of video streams (e.g., video streams 711 to 713) according to a first mapping relation (or correspondence relation) between “video streams to be combined into a single video stream” and “slice groups (i.e., target screen areas on a single display screen).”

For example, (i) video stream 711 of CH #1 may be mapped to slice group 0 (“721”), (ii) video stream 712 of CH #2 may be mapped to slice group 1 (“722”), and (iii) video stream 713 of AD #1 (e.g., common advertisements provided regardless of user characteristics) may be mapped to slice group 2 (“723”). Herein, a background image may be mapped to “slice group 3 (background group)” (“724”). The background image may be determined by at least one of video stream combination server (e.g., 120), management server 190, and a user selection. In other embodiments, as shown in FIG. 8B, the first single combined video stream (e.g., 720) may be formed without the background group (e.g., slice group 3 (“724”)).

Meanwhile, a second video stream combination server (e.g., 150a, . . . , or 150n) corresponding to a local video stream combination server may receive the first single combined video stream (e.g., 720) which includes a plurality of encoded video data (e.g., 721 to 723) corresponding to a plurality of video streams, from the first video stream combination server (e.g., 120). In this case, referring to FIG. 7C, the second video stream combination server (e.g., 150a, . . . , or 150n) may create a second single combined video stream (e.g., 740) by combining the first single combined video stream (e.g., 720) and at least one other video stream (e.g., a local advertisement stream, for example AD #2 (“730”)). More specifically, as described in FIG. 7C, the second video stream combination server (e.g., 150a, . . . , or 150n) may create the second single combined video stream (e.g., 740) by deploying a plurality of video streams (e.g., video streams 721, 722, 723, and 730) using a second mapping relation (or correspondence relation) between “video streams to be combined into a single video stream” and “slice groups (i.e., target screen areas on a single display screen).”

For example, (i) video stream 721 of CH #1 may be mapped to slice group 0 (“741”), (ii) video stream 722 of CH #2 may be mapped to slice group 1 (“742”), (iii) video stream 723 of AD #1 (e.g., common advertisements provided regardless of user characteristics) may be mapped to slice group 2 (“743”), and (iv) video stream 730 of AD #2 (e.g., a local advertisement stream) may be mapped to slice group 3 (“744”). Herein, a background image may be mapped to “slice group 4 (background group)” (“745”). The background image may be determined by at least one of video stream combination server (e.g., 120), management server 190, and a user selection. In other embodiments, as shown in FIG. 8B, the second single combined video stream (e.g., 740) may be formed without the background group (e.g., slice group 4 (“745”)).

As described above, a background part (e.g., “724” or “745”) of a single combined video stream screen may be considered and processed as a slice group (e.g., slice group 3 in FIG. 7B, or slice group 4 in FIG. 7C). Alternatively, in the case that the background part (e.g., “724” or “745”) is configured in a form of UI template, the UI template may be provided as metadata to user equipment.

FIG. 8A and FIG. 8B illustrate a concept of a video stream combination which is performed in a unit of frame in accordance with at least one embodiment.

FIG. 8A illustrates a video combination procedure of forming a single combined video stream by combining three video streams (e.g., two broadcast channel streams and one video advertisement stream, or three broadcast channel streams). In particular, FIG. 8A illustrates embodiments including a slice group corresponding to a background group.

As shown in FIG. 8A, each video stream (e.g., 80, 81, and 82) may include a plurality of image frames. For example, video stream 80 (e.g., video streams of CH #1) may include a plurality of image frames such as frame #0 (801), frame #1 (802), frame #2 (803), and frame #3 (804). Video stream 81 (e.g., video streams of CH #2) may include a plurality of image frames such as frame #0 (811), frame #1 (812), frame #2 (813), and frame #3 (814). Video stream 82 (e.g., video streams of AD #1) may include a plurality of image frames such as frame #0 (821), frame #1 (822), frame #2 (823), and frame #3 (824).

In this case, a single combined video stream may be formed using “corresponding encoded video data” included in the three video streams (80, 81, 82) in a unit of frame. More specifically, combined frame #0 (841) of the single combined video stream 84 may be formed using (i) encoded video data corresponding to frame #0 (801) of video stream 80, (ii) encoded video data corresponding to frame #0 (811) of video stream 81, (iii) encoded video data corresponding to frame #0 (821) of video stream 82, and (iv) encoded video data corresponding to a background image. In this case, each of the plurality of encoded video data may be size-adjusted, and then be processed as slice group data. In the same manner, combined frame #1 (842), combined frame #2 (843), and combined frame #3 (844) may be formed.

Meanwhile, FIG. 8B illustrates a video combination procedure of forming a single combined video stream by combining four video streams (e.g., three broadcast channel streams and one video advertisement stream, or four broadcast channel streams). In particular, FIG. 8B illustrates embodiments not including a slice group corresponding to a background group. As described in FIG. 8B, a single combined video stream 85 may be formed by combining four video streams (80, 81, 82, and 83) in a unit of frame. More specifically, combined frame #0 (851) of the single combined video stream 85 may be formed using (i) encoded video data corresponding to frame #0 (801) of video stream 80, (ii) encoded video data corresponding to frame #0 (811) of video stream 81, (iii) encoded video data corresponding to frame #0 (821) of video stream 82, and (iv) encoded video data corresponding to frame #0 (831) of video stream 83. In this case, combined frames of the single combined video stream 85 may be formed without a background image.

More specifically, a video stream combination server according to at least one embodiment may extract required portions (i.e., encoded video data) from the bitstreams of a plurality of video streams (e.g., broadcast channel streams received from broadcast servers, and/or at least one advertisement video stream to be newly added), and create a single combined video stream using the extracted bitstream portions (i.e., encoded video data). Such video stream combination scheme using a plurality of encoded video data extracted from a plurality of video streams will be described in more detail with reference to FIG. 9.

FIG. 9 illustrates a bitstream structure of a single combined video stream in accordance with at least one embodiment.

As described in FIG. 8A and FIG. 8B, a single combined video stream (i.e., a single video stream created by combining a plurality of video streams) may be a set of combined frames (e.g., 84, 85). Herein, the combined frames (e.g., 84, 85) may be created using a plurality of encoded video data extracted from the plurality of video streams (e.g., 80, 81, 82, 83) in a unit of frame. In this case, each of the plurality of encoded video data may be size-adjusted, and then be processed as slice group data.

FIG. 9 illustrates a bitstream structure (e.g., H.264 bitstream structure) to which FMO type 2 is applied, in the case that each combined frame of a single video stream is formed by four slice groups. For example, as shown in FIG. 8A, four slice groups may include (i) three slice groups for three video streams, and (ii) one slice group corresponding to a background group. Alternatively, as shown in FIG. 8B, four slice groups may include four slice groups for four video streams without a background group.

For example, “91” represents a bitstream structure associated with “combined frame 841” or “combined frame 851.” Herein, each “slice group data” field may include “encoded video data” (more specifically, size-adjusted encoded video data) corresponding to each video stream (e.g., CH #1, CH #2, AD #1, or AD #2). “92” represents a bitstream of “combined frame 842” or “combined frame 852.” Each “slice group header” field may include position information (i.e., information on a position of the slice group in a corresponding combined frame) on a corresponding slice group.

In other embodiments, the background group (e.g., “724” in FIG. 7B, “745” in FIG. 7C) may be configured with a UI template. In this case, the UI template may be provided as metadata to user equipment.

FIG. 10 illustrates an exemplary user interface (UI) for providing a plurality of video streams on a single screen of user equipment in accordance with at least one embodiment.

Referring to FIG. 10, when receiving a single video stream (i.e., a combined video stream) including a plurality of video stream (e.g., a broadcast channel stream, a video advertisement stream) from a video stream combination server (e.g., 120, 150a, . . . , or 150n), user equipment may decode the received single combined video stream using a single decoder, and then display the decoded single combined video stream. In this case, a plurality of encoded video data (i.e., a plurality of encoded video data associated with a plurality of video streams) included in the single video stream may be displayed on a single screen (e.g., 1000) of the user equipment. For example, as shown in FIG. 10, (i) a variety of broadcast streams associated with a plurality of broadcast channels (e.g., CH #1, CH #2, CH #3, CH #4) and (ii) video advertisement streams (e.g., AD #1, AD #2) may be displayed on a single screen (e.g., 1000) of the user equipment.

In other embodiments, a user-side video stream combination server (e.g., 180) may receive (i) a single combined video stream including broadcast data and advertisement data, from a higher video stream combination server (e.g., 150n), and/or (ii) receive additional video streams from a variety of user-side video providing devices (e.g., 185). Herein, the user-side video combination server (e.g., 180) may be a home gateway including a video combination processor (e.g., 22, 32). The user-side video providing devices (e.g., 185) may include a CCTV, a smart phone, and/or a communication terminal. The additional video streams may include CCTV video data, smart phone video data (e.g., video data obtained using a smart phone), and/or personal video data of a user. Accordingly, the user-side video stream combination server (e.g., 180) may create another single combined video stream (i.e., a third single combined video stream) by combining the additional streams and the received single video stream, and provide the third single combined video stream to corresponding user equipment (e.g., UE #n in local area #170n).

In at least one embodiment, as shown in FIG. 10, a display screen of user equipment may have a mosaic-type screen structure (e.g., 3×3 mosaic type screen, 2×2 mosaic type screen), but is not limited thereto.

FIG. 11A and FIG. 11B illustrate a method of adding a guard area in order to overcome a decoding error at a boundary portion of slice groups in accordance with at least one embodiment.

As shown in FIG. 11A, in the case that a video combination (e.g., image stitching) is performed using an FMO technique, a video decoding may not be properly performed at a boundary of image frames to be combined, due to influence of neighboring slice data. Furthermore, in this case, such decoding error (i.e., a distortion in decoded images) may be propagated to a neighboring portion from the boundary. More specifically, in an H.264 standard, in case of a boundary of each image frame, there may be no macroblock data to be used as reference blocks. Accordingly, in this case, a typical encoding scheme may perform an encoding procedure after padding reference blocks having a specific value (e.g., 0 or 128). However, in the case that a video combination (e.g., video stitching) is performed as shown in FIG. 11A, boundary portions of each slice group (i.e., each slice group corresponding to a video frame to be combined) may be filled with macroblocks of other neighboring slice groups, and then a decoding procedure may be performed. In other words, in case of a single combined video stream, a decoding procedure at a boundary portion (e.g., 1100) of slice groups may be performed using macroblock data of other neighboring slice groups other than the above-described padding macroblock data (e.g., 0 or 128), thereby resulting in a decoding error.

Meanwhile, as shown in FIG. 11B, in order to prevent such decoding error (i.e., a distortion in decoded images), the present embodiment may introduce (or set) a guard area (e.g., 1102) at a boundary of each image frame to be combined (e.g., stitched). Herein, the guard area may be formed through a zero padding. Furthermore, as shown in FIG. 11B, macroblocks surrounding each image frame to be combined (e.g., stitched) may be determined as the guard area. Accordingly, in the case that a single combined video stream is decoded, neighboring slice groups including the guard area may have the same block value (e.g., zero) at a boundary portion, and thereby preventing an image distortion due to neighboring other slice groups.

The present embodiment may create a single combined video stream (e.g., a single mosaic-type video stream) by combining a plurality of encoded video streams in a mosaic type arrangement, without performing decoding each of the encoded video stream. More specifically, when receiving a single mosaic-type video stream (i.e., a single combined video stream), user equipment may decode the single mosaic-type video stream using a single decoder, and thereby displaying a plurality video streams on a single screen without having a plurality of decoders corresponding to the number of video streams. In other words, even in case of a low-performance user equipment having a single decoder, a plurality of video streams may be displayed at the same time on a single screen.

Furthermore, the present embodiment may create a single combined video stream by combining at least one broadcast stream (e.g., broadcast channel streams) and at least one video advertisement stream (e.g., a common advertisement stream or a local advertisement stream suitable for a user or a specific location). Particularly, the present embodiment may provide a video advertisement (i.e., a dynamic advertisement based on a video stream) other than a static advertisement (e.g., a text advertisement, a static image advertisement). Accordingly, the present embodiment may provide a variety of targeted video advertisement to users, without a change of a typical (or existing) broadcast platform. More specifically, in at least one embodiment, when receiving a broadcast stream which is transmitted through a multicast transmission scheme, a local node including a video stream combination server may create a single combined video stream by combining (e.g., stitching) the receive broadcast stream and a targeted video advertisement stream, and provide the single combined video stream to user equipment through a unicast transmission scheme. In this case, a targeted video advertisement (e.g., a local video advertisement) may be added (or combined) through a video stitching and be transmitted through a unicast transmission scheme at a local stage (e.g., by the local node), and therefore a consumption of network bandwidth may be efficiently reduced.

Furthermore, the present embodiment may provide broadcast channel services (excluding a video advertisement such as a local advertisement) to charged subscribers, and provide a combined video stream service (including a video advertisement, especially a local advertisement) to free users. In other words, the present embodiment may enable the diversification of profit models.

Meanwhile, in at least one embodiment, methods of performing a video combination (e.g., an image stitching), and/or methods of providing a video advertisement (e.g., a common advertisement or a local advertisement) using the video stream combination scheme may be embodied in the form of a computer-readable recording medium (e.g., a non-transitory computer-readable recording medium) storing a computer executable program that, when executed, causes a computer to perform the method(s).

Furthermore, a single combined video stream according to the present embodiments may be used as a channel guide stream.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of performing a video stream combination, the method comprising:
receiving a plurality of independent video streams;
extracting encoded video data in a unit of video frame from each of the plurality of independent video streams;
creating a plurality of slice group data to be used for creation of a single combined video stream, from a plurality of encoded video data;
creating slice group header information per slice group data; and
forming the single combined video stream including the plurality of slice group data and a plurality of slice group header information.

2. The method of claim 1, wherein the creating a plurality of slice group data includes at least one of:
adjusting a data size of each encoded video data; and
adding guard area data to each encoded video data.

3. The method of claim 2, wherein the adjusting includes:
performing a data size adjustment such that each encoded video data is displayed at a predetermined screen area on a target display screen.

4. The method of claim 3, wherein the data size adjustment is performed according to a mapping relation of each video stream and a slice group corresponding to the target screen area.

5. The method of claim 2, wherein the adding guard area data includes:
adding the guard area data to each size-adjusted encoded video data such that a decoding error due to neighboring slice groups is prevented.

6. The method of claim 1, wherein at least one of the plurality of independent video streams is an advertisement video stream.

7. The method of claim 1, wherein the slice group header information includes:
position information associated with each slice group corresponding to each slice group data.

8. The method of claim 7, wherein the position information is determined such that each encoded video data is displayed at a predetermined screen area on a target display screen.

9. The method of claim 1, further comprising:
creating a single combined transport stream (TS) by multiplexing at least one of the single combined video stream, corresponding audio streams, and additional information.

10. The method of claim 9, wherein the additional information includes at least one of (i) metadata associated with the single combined video stream, and (ii) access information of content servers providing the plurality of independent video streams.

11. The method of claim 1, further comprising:
performing a frame type synchronization for the plurality of slice group data.

12. The method of claim 1, wherein in a case that at least one of the plurality of independent video streams is a different single combined video stream, the extracting includes:
extracting a plurality of encoded video data in a unit of video frame from the different single combined video stream.

13. The method of claim 1, wherein the slice group data and the slice header information are based on a flexible macroblock ordering (FMO) technique.

14. A method of providing an advertisement using a video stream combination, the method comprising:
receiving at least one video stream from at least one content providing server;
receiving at least one advertisement stream from at least one advertisement server;
extracting encoded video data in a unit of video frame, from each of the at least one video stream and the at least one advertisement stream;
creating a plurality of slice group data to be used for creation of a single combined video stream, from a plurality of encoded video data;
creating slice group header information per slice group data; and
forming the single combined video stream including the plurality of slice group data and a plurality of slice group header information.

15. The method of claim 14, wherein at least one of the at least one advertisement stream is a local advertisement stream associated with user characteristics.

16. The method of claim 14, wherein the creating a plurality of slice group data includes at least one of:
adjusting a data size of each encoded video data such that each encoded video data is displayed at a predetermined screen area on a target display screen; and
adding guard area data to each encoded video data.

17. The method of claim 16, wherein in a case that at least one of the at least one video stream is a different single combined video stream, the extracting includes:
extracting a plurality of encoded video data in a unit of video frame from the different single combined video stream.

18. A system for performing a video stream combination, the system comprising:
a receiver configured to receive a plurality of independent video streams;
a video combination processor configured to (i) extract encoded video data in a unit of video frame from each of the plurality of independent video streams, (ii) create a plurality of slice group data to be used for creation of a single combined video stream, from a plurality of encoded video data, (iii) create slice group header information per slice group data, and (iv) form the single combined video stream including the plurality of slice group data and a plurality of slice group header information; and
a transmitter configured to transmit the single combined video stream to at least one of another video stream combination server and user equipment.

19. The system of claim 18, wherein the video combination processor is configured to create the plurality of slice group data by performing at least one of:
(i) a data size adjustment procedure for each encoded video data such that each encoded video data is displayed at a predetermined screen area on a target display screen; and
(ii) a guard area adding procedure for preventing a decoding error due to neighboring slice groups.

20. The system of claim 19, wherein in a case that at least one of the plurality of independent video streams is a different single combined video stream,
the video combination processor is configured to extract a plurality of encoded video data in a unit of video frame from the different single combined video stream.
